(19) United States
(12) Patent Application Publication
(10) Pub. No.: US 2007/0077169 A1
(43) Pub. Date: Apr. 5, 2007

(54) Microchip and liquid mixing method and blood testing method using this microchip

(75) Inventors: Bo Yang, Asaka-shi (JP); Yoshiki Sakaino, Asaka-shi (JP); Hideyuki Karaki, Minami-Ashigara-shi (JP); Akira Wakabayashi, Minami-Ashigara-shi (JP)

Correspondence Address: BIRCH STEWART KOLASCH & BIRCH, PO BOX 747, FALLS CHURCH, VA, 22040-0747, US

(73) Assignee: FUJI PHOTO FILM CO., LTD.

(21) Appl. No.: 11/527,698

(22) Filed: Sep. 27, 2006

(30) Foreign Application Priority Data
Sep. 27, 2005 (JP) P2005-279931
Sep. 22, 2006 (JP) P2006-257568

(51) Int. Cl. G01N 1/00

(52) U.S. Cl. 422/57; 436/174; 366/341; 366/336; 366/348

(57) ABSTRACT

A microchip comprises: a flow path substrate; an inlet port; a flow path adapted to cause a plurality of kinds of liquid to flow while mixing the plurality of kinds of liquid; and a decompression port configured to communicate with the flow path and to be connectable to a decompression unit, wherein the flow path includes a first flow path portion and a second flow path portion provided so that they are alternately formed, and wherein the first flow path portion has a larger cross-sectional area than the flow path portion other than the first flow path portion, and wherein the second flow path portion has a smaller cross-sectional area than the first flow path portion; and a blood test method comprises: mixing a blood with a dilute solution by utilizing the microchip described above.

### BACKGROUND OF THE INVENTION

1. Field of the Invention

The present invention relates to a microchip, and to a liquid mixing method and a blood testing method, which use this microchip.

2.Description of the Related Art

Hitherto, there have been techniques of mixing a plurality of kinds of liquid, which are disclosed in JP-A-2001-120972, JP-A-2002-346355 and JP-A-2003-1077.

### SUMMARY OF THE INVENTION

However, methods described in the above JP-A-2001-120972, JP-A-2002-346355 and JP-A-2003-1077 are unsuitable for mixing two kinds of liquid, which differ from each other in viscosity, specific gravity, and content ratio. Also, these methods are unsuitable for mixing liquid solutions in accordance with use intended to perform mixing by continuously sending solutions and to produce a given amount of a mixture of the solutions (that is, produce a certain amount, for example, a total of 20 μL of the mixture, instead of continuously mixing the solutions). For instance, in the case of mixing a minute amount of blood with a dilute solution in a blood test, the blood and the dilute solution cannot uniformly be mixed by the above methods.

The invention is accomplished in view of the above circumstances. Accordingly, an object of the invention is to provide a microchip enabled to simply mix given amounts of a plurality of kinds of liquid, which differ in viscosity, specific gravity, and content ratio from one another, and to provide a mixing method using the microchip.

The above object is achieved by the following microchips and methods.

(1) A microchip, which comprises:

a flow path substrate;

an inlet port formed in the flow path substrate so that a plurality of kinds of liquid is introduced thereinto;

a flow path adapted to cause the plurality of kinds of liquid introduced into the inlet port to flow while mixing the plurality of kinds of liquid; and

a decompression port configured to communicate with the flow path and to be connectable to a decompression unit when atmosphere in the flow path is decompressed,

wherein the flow path includes a first flow path portion and a second flow path portion provided so that the first flow path portion and the second flow path portion are alternately formed, and

wherein the first flow path portion has a larger cross-sectional area of a cross-section perpendicular to a direction, in which the liquid flows, than the flow path portion other than the first flow path portion, and

wherein the second flow path portion has a smaller cross-sectional area of a cross-section perpendicular to the direction, in which the liquid flows, than the first flow path portion.

(2) The microchip as described in (1) above,

wherein the cross-sectional area of the first flow path portion is equal to or larger than twice the cross-sectional area of the second flow path portion.

(3) The microchip as described in (1) or (2) above,

wherein a capacity of the first flow path portion is equal to or larger than 80% of a total volume of the plurality of kinds of liquid.

(4) The microchip as described in any of (1) to (3) above,

wherein a length in a direction parallel to the direction, in which the liquid flows, of the first flow path portion ranges from 0.1 to 10 times a length in a direction parallel to the direction, in which the liquid flows, of the second flow path portion.

(5) The microchip as described in any of (1) to (4) above,

wherein a corner portion of a bottom surface of the flow path has a curvature radius that is equal to or larger than 10% of a flow path width.

(6) The microchip as described in any of (1) to (5) above,

wherein the number of the inlet port is 1.

(7) The microchip as described in any of (1) to (6) above,

wherein the plurality of kinds of liquid reciprocates in the flow path.

(8) A liquid mixing method, which comprises:

mixing a plurality of kinds of liquid by utilizing a microchip as described in any of (1) to (7) above.

(9) The liquid mixing method as described in (8) above,

wherein at least one kind of liquid among the plurality of kinds of liquid is preliminarily inputted to the inlet port.

(10) A blood test method, which comprises:

mixing a blood with a dilute solution by utilizing a microchip as described in any of (1) to (7) above.

(11) A microchip, which comprises:

a flow path substrate;

an inlet port formed in the flow path substrate so that a plurality of kinds of liquid is introduced thereinto; and

a flow path adapted to cause the plurality of kinds of liquid introduced into the inlet port to flow while mixing the plurality of kinds of liquid,

wherein the inlet port is connectable to a compression unit when atmosphere in the flow path is compressed, and

wherein the flow path includes a first flow path portion and a second flow path portion provided so that the first flow path portion and the second flow path portion are alternately formed, and

wherein the first flow path portion has a larger cross-sectional area of a cross-section perpendicular to a direction, in which the liquid flows, than the flow path portion other than the first flow path portion, and

wherein the second flow path portion has a smaller cross-sectional area of a cross-section perpendicular to the direction, in which the liquid flows, than the first flow path portion.

The microchip according to the invention is configured so that a plurality of kinds of liquid to be mixed is inputted to an inlet port, that atmosphere in the flow path is pressurized or depressurized by connecting a decompression unit to a decompression port, and that the plurality of kinds of liquid inputted to the inlet port is moved together along the flow path. When liquid is moved from a second flow path portion, whose cross-sectional area is small, to a first flow path portion, whose cross-sectional area is larger than the cross-sectional area of the second flow path portion, while the plurality of kinds of liquid flows in the flow path, diffusion is performed on the plurality of kinds of liquid due to turbulent. Thus, when the plurality of kinds of liquid is caused to flow in the flow path, the diffusion is performed thereon in the first flow path portions. The first flow path portions and the second flow path portions are alternately and continuously formed along the flow path, the plurality of kinds of liquid is gradually mixed with one another. Consequently, the use of a microchip according to the invention enables the uniform mixing of minute amounts of blood and a dilute solution. Additionally, a microchip according to the invention is used in a blood test method, so that the mixing of blood can efficiently and surely be achieved.

### BRIEF DESCRIPTION OF THE DRAWINGS

FIG. 1 is a diagram illustrating the configuration of a microchip according to the invention;

FIGS. 2A to 2F are diagrams illustrating a process of mixing blood with a dilute solution using the microchip;

FIG. 3 is a graph illustrating the calibration curve of an analysis element used to measure glycohemoglobin; and

FIG. 4 is a graph illustrating the calibration curve of an analysis element used to obtain an amount of CRP, wherein 10 denotes microchip, 11 denotes flow path substrate, 12 denotes inlet port, 13 denotes decompression port, 14 denotes flow path, p11-p19 denote second flow path portions, and p21-p28 denote first flow path portions.

### DETAILED DESCRIPTION OF THE INVENTION

Hereinafter, an embodiment of the invention is described in detail with reference to the accompanying drawings.

First, the configuration of a microchip according to the invention is described below.

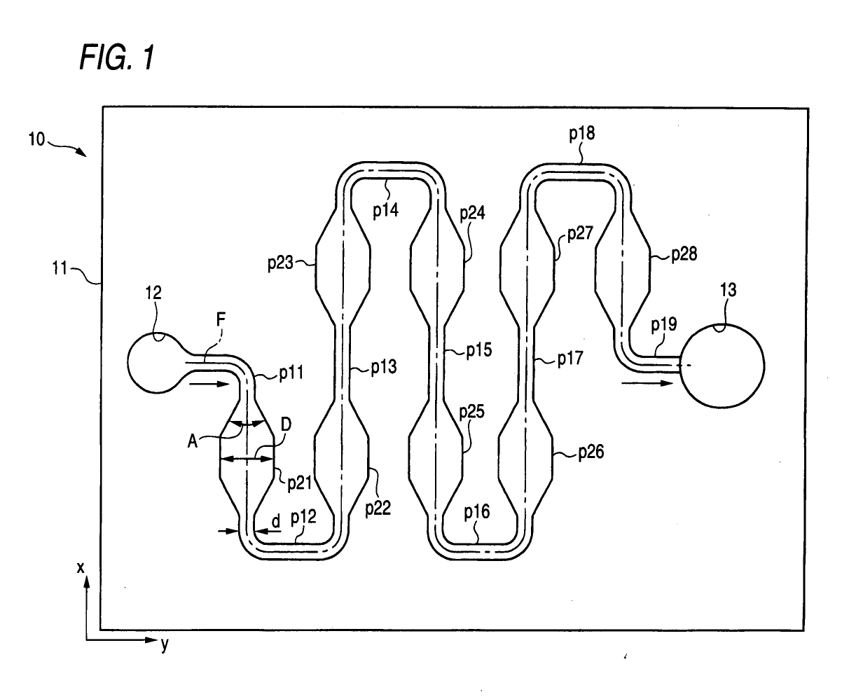

As shown in FIG. 1, the microchip 10 has a flow path substrate 11. In the flow path substrate 11, an inlet port 12 into which a plurality of kinds of liquid is introduced, a flow path 14 adapted to cause the plurality of kinds of liquid to flow while mixing the plurality of kinds of liquid, and a decompression port 13 configured to communicate with the flow path 14.

A decompression unit adapted to decompress atmosphere in the flow path 14 can be connected to the decompression port 13. The decompression of the atmosphere in the flow path 14 by the decompression unit causes the plurality of kinds of liquid preliminarily introduced into the inlet port to flow in the flow path 14 toward the decompression port 13.

In the flow path 14, first flow path portions and second flow path portions are alternately formed along a direction (indicated by a dot-dash line designated by “F” in FIG. 1), in which liquid flows. The first flow path portions p21, p22, p23, p24, p25, p26, p27, and p28 (here under generically referred to as a first flow path portion) are configured so that the cross-sectional area of a cross-section perpendicular to a direction, in which liquid flows in the flow path 14, of each of the first flow path portions is larger than the cross-section area of a cross-section perpendicular to this direction of each of flow path portions other than the first flow path portions. The second flow path portions p11, p12, p13, p14, p15, p16, p17, p18 and p19 (hereunder generically referred to as a second flow path portion) are configured so that the cross-sectional area of a cross-section perpendicular to a direction, in which liquid flows in the flow path 14, of the second flow path portion is smaller than the cross-section area of a cross-section perpendicular to this direction of the first flow path portion.

In the microchip 10 according to the present embodiment, the second flow path portion p1, the first flow path portion p21, the second flow path portion p12, the first flow path portion p22, the second flow path portion p13, the first flow path portion p23, the second flow path portion p14, the first flow path portion p24, the second flow path portion p15, the first flow path portion p25, the second flow path portion p16, the first flow path portion p26, the second flow path portion p17, the first flow path portion p27, the second flow path portion p18, the first flow path portion p28, and the second flow path portion p19 are arranged along a flow direction F, in which liquid flows, in this order and communicate with the inlet port 12. A decompression port 13 communicates with the second flow path portion p19.

There is no particular limitation to the number of the first flow path portions and the second flow path portions formed in the flow path 14. Preferably, at least one second flow path portion and first flow path portions, which are respectively positioned immediately anterior and posterior to this second flow path portion in the flow direction F, are provided in the flow path 14.

In the present embodiment, the flow path 14 is formed substantially like a wave in plan view of the flow path substrate to detour in a direction (designated by an arrow x in FIG. 1) perpendicular to a direction (designated by an arrow y in FIG. 1) from the inlet port 12 to the decompression port 13. However, the shape of the flow path 14 is not limited thereto. The shape of the flow path 14 can appropriately be changed within a range in which the first flow path portion and the second flow path portion can alternately be formed.

Next, an example of a method of manufacturing the microchip 10 according to the invention is described below.

The microchip 10 is manufactured by fabricating a flow path substrate on a surface of a plate with a microdrill. The material of the flow path substrate 11 maybe either an inorganic material or an organic material. Examples of the inorganic material used in the flow path substrate 11 are metal, silicon, Teflon (registered trademark), glass, and ceramics. Examples of the organic material are a plastic material and a rubber material.

Examples of the plastic material are COP, PS, PC, PMMA, PE, PET, and PP. Examples of the rubber material are a natural rubber, a synthetic rubber, a silicon rubber, and PDMS (polydimethylsiloxane). Examples of a silicon-containing material are glass, quartz, amorphous silicon such as silicon wafer, and silicon, such as polymethylsiloxane.

Particularly preferred examples of the material are PMMA, COP, PS, PC, PET, PDMS, glass, and silicon wafer.

There is no particular limitation to the details of the shape of the flow path 14. Although the flow path 14 may have any shape, for example, a linear shape and a curved shape, a linear shape is preferable. Preferably, the shape of a thick expansion part of the first flow path portion is a hexagon, a circle, a quadrangle, and a polygon. More preferably, the shape of the thick expansion part of the first flow path portion is a hexagon. This facilitates the diffusion of a plurality of kinds of liquid caused to flow. To enhance the flow ability of liquid, it is desirable to form the corner portion of the polygon into a chamfered shape.

The width of a narrow part flow path of the second flow path portion can appropriately be increased or decreased when needed. In a case where an amount of a specimen is small, preferably, the narrow part flow path of the second flow path portion is a micro-flow-path. In the present specification, the “micro-flow-path ” is defined to be a flow path whose equivalent diameter is equal to or less than 3 mm.

The equivalent diameter according to the invention is a term generally used in the field of mechanical engineering. In a case where a circular tube equivalent to a cross-sectionally and optionally shaped pipe (corresponding to a flow path according to the invention) is assumed, the diameter of the equivalent circuit tube is referred to an equivalent diameter. Thus, an equivalent diameter (deq) is defined as follows:
deq=4A/p
where “A” is a cross-sectional area of the pipe, and “p” is a wetted perimeter of the pipe. In a case where this definition is applied to a circular tube, this equivalent diameter is equal to the diameter of the circuit tube. The equivalent diameter is used to estimate the fluid flow characteristic and the heat transfer characteristic of the pipe according to data representing the equivalent circuit tube. The equivalent diameter thereof represents the spatial scale of a phenomenon (representative length thereof). The equivalent diameter of a regular tetragon, which is “a” on a side”, is given as follows:
deq=4a²/4a=a.
In the case of a flow flowing between parallel plates, the path height between which is h, the equivalent diameter is given as follows:
deq=2h.
The details of the equivalent diameter are described in “Mechanical Engineering Dictionary” edited by The Japan Society of Mechanical Engineers (1997), published by Maruzen Co., Ltd.

The equivalent diameter of the micro-flow-path used according to the invention is 3 mm or less, preferably, 10 μm to 2000 μm, more preferably, 20 μm to 1000 μm.

There is no particular limitation to the length of the flow path 14. However, preferably, the length of the flow path 14 is 1 mm to 10000 mm, more preferably, 2 mm to 100 mm.

Preferably, the width of the flow path 14 according to the invention is 1 μm to 3000 μm, more preferably, 10 μm to 2000 μm, further preferably, 50 μm to 1000 μm. Preferably, in a case where the width of the flow path 14 is within the above ranges, the specimen, such as blood, suffer little resistance from the wall of the flow path 14. Thus, there is little reduction in the flow ability. Also, an amount of the specimen can be confined to a small amount thereof. Accordingly, it is preferable that the width of the flow path 14 is within the above ranges.

Preferably, the cross-sectional area of a cross-section perpendicular to the flow direction F of the first flow path portion is equal to or larger than twice that of a cross-section perpendicular to the flow direction F of the second flow path portion. More preferably, the cross-sectional area of a cross-section perpendicular to the flow direction F of the first flow path portion is equal to or larger than three-times that of a cross-section perpendicular to the flow direction F of the second flow path portion. Preferably, the capacity of the first flow path is equal to or more than 80% of the total capacity of the plurality of kinds of liquid.

Preferably, the length in a direction parallel to a direction, in which liquid flows, of the first flow path portion ranges from 0.1 times to ten times the length in a direction parallel to the direction, in which liquid flows, of the second flow path portion.

In the flow path 14, a plurality of first and second flow path portions are provided so that the first flow path portion and the second flow path portion are alternately placed. Preferably, the number of the first and second flow path portions ranges from 1 to 100, more preferably, from 3 to 50, furthermore preferably, from 5 to 15.

A liquid mixing method according to the invention may be performed along a mixing flow path only in one of backward and forward directions of the flow path . Alternatively, the liquid mixing method according to the invention may be performed along the flow path in a reciprocating manner.

Preferably, a hydrophilization or hydrophobilization treatment is performed on the inner surface of the flow path 14. In the case of an aqueous specimen, a hydrophilization treatment is needed. In the case of an oily specimen, a hydrophobilization treatment is needed. Conventional surface treatments can be applied as hydrophilization and hydrophobilization treatments. The surface treatments are roughly classified into chemical surface treatment methods and physical surface treatment methods. Examples of the chemical surface treatment method are chemical treatments, coupling-agent treatments, steaming, graftization, electrochemical treatments, and surface reforming using an addition agent. Examples of the physical surface treatment method are UV irradiation methods, electron beam treatments, low-temperature plasma treatments, CASING treatments, glow-discharge treatment methods, corona-discharge treatment methods, and oxygen plasma treatments.

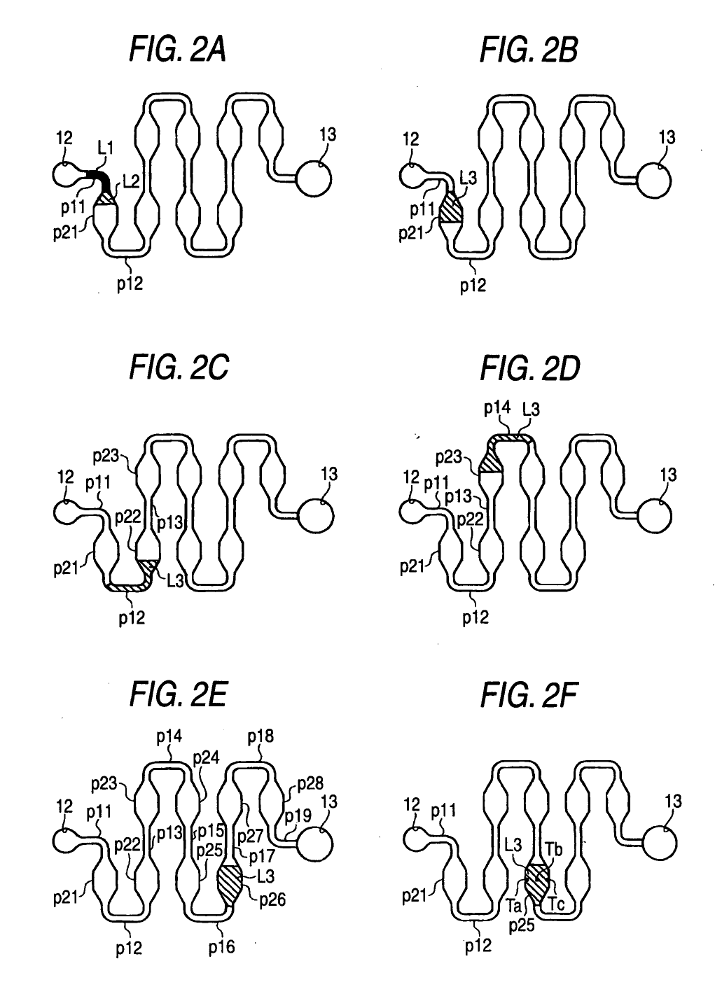

Next, a procedure for mixing blood with a dilute solution is described below by referring to the accompanying drawings. FIGS. 2A to 2F illustrate a procedure for mixing two kinds of liquid (blood and a dilute solution in this embodiment) using a microchip.

First, 0.5 μl of blood L1 and 25 μl of the dilute solution L2 are inputted to the inlet port 12. Also, the decompression of the flow path is started by a decompression unit (for example, a syringe pump) connected to the decompression port 13. Alternatively, the pressurization of the inside of the flow path may be started by connecting a compression unit (compression means) to the inlet port 12. Alternatively, a system of reciprocating the blood L1 and the dilute solution L2 in the flow path may be used.

When the decompression is started, as shown in FIG. 2A, the dilute solution L2, which is low in specific gravity and in viscosity, is introduced into the flow path 14, ahead of the blood L1. Subsequently, the blood L1 is introduced into the inside of the flow path . In a case where the expansion and contraction of the cross-section of the flow path 14 are performed, the blood is not mixed with the dilute solution.

When the dilute solution L2 having flow ed into the first flow path portion p21 through the second flow path portion p11 is diffused in the first flow path portion p21 in response to the expansion of the inner space of a part extending from the second flow path portion p11 to the first flow path portion p21 of the flow path 14. Subsequently, the blood L1 is similarly diffused in the first flow path portion p21. Thus, the diffusion of both the blood L1 and the dilute solution L2 is performed, so that the blood L1 and the dilute solution L2 are mixed with each other (see FIG. 2B). Hereunder, a mixture of the blood L1 and the dilute solution L2 is designated by L3.

Subsequently, when the mixture L3 moves from the second flow path portion p12 to the first flow path portion p22, as shown in FIG. 2C, the diffusion of the mixture L3 is performed again. Thus, in the flow path portion p22, the blood L1 and the dilute solution L2 are further mixed.

As illustrated in FIGS. 2D to 2E, the mixture L3 alternately flows the first flow path portion and the second flow path portion. Thus, the blood L1 and the dilute solution L2 are further gradually mixed with each other.

Incidentally, to efficiently mix a plurality of kinds of liquid with one another, preferably, the capacity of the first flow path portion, whose cross-sectional area is larger, is substantially equal to or larger than the total capacity of two kinds of liquid to be mixed. In the case of inputting three kinds or more of liquid, preferably, the capacity of the first flow path portion is substantially equal to or larger than the total capacity of a plurality of kinds of liquid to be mixed.

In the case of manufacturing the flow path with a microdrill, it is efficient to set the depth of the flow path at a constant value. In this case, the expansion/contraction of the cross-sectional area of the flow path 14 is conducted by performing the increase/reduction of the width dimension of the flow path 14 (dimensions D and d perpendicular to the flow direction F in plan view of the flow path substrate 11). Preferably, the expansion or contraction of the cross-sectional area is gradually performed to prevent the run-out of liquid and the mixing of air bubbles into the liquid. Also, preferably, the corner portions are chamfered. In the case of performing the expansion/contraction by changing the width of the flow path, the shape of each part to be expanded or contracted is a triangle. Preferably, a spread angle (that is, an angle A shown in FIG. 1) is equal to or less than 90 degrees.

Also, to minimum residual liquid at a halfway part of the flow path , the corner portions of the bottom surface of the flow path is chamfered. The appropriate size of each chamfered part ranges from ( 1/10) to (½) of the width of the flow path.

### EXAMPLES

Hereinafter, the invention is described in detail by describing example and comparative examples. However, the invention is not limited to the examples.

### First Example

### Manufacture of Mixing Flow Path

The flow path substrate was manufactured on the surface of a resin plate by a microdrill (see FIG. 1). Subsequently, the flow path substrate was plasma-hydrophilization-treated 15 minutes, together with a PDMS having the same size as that of the flow path substrate. Then, the PDMS plate was mounted on the flow path substrate. The sealed condition of the flow path was established by utilizing a self-adhesive force of the PDMS plate. Thus, the mixing flow path was completed. An inlet port for introducing liquid to be mixed, and a hole having a size suitable for being used as a decompression unit connecting portion (decompression port) thereto were bored in the PDMS plate.

### Second Example

### Checking of Effect of Mixing

A test of mixing two kinds of liquid, which differ in properties from each other, was conducted using the flow path manufactured in the first example.

First, 0.5 μl of blood and 25 μl of the dilute solution were inputted to the inlet port with a pipette. Then, the decompression of the flow path was commenced using a compression unit (for example, a syringe pump) connected to the decompression unit connecting portion of the PDMS plate.

When the decompression was started, the dilute solution, which was low in specific gravity and in viscosity, was introduced into the flow path ahead of the blood. Subsequently, the blood was introduced into the flow path. This example had an effect of diffusion of the liquid due to the expansion of the cross-sectional area of the flow path. This process was repeated several times to thereby gradually mix the two kinds of liquid with each other.

It could be confirmed by a photograph that the blood and the dilute solution were uniformly mixed with each other. Simultaneously, as shown in FIG. 2F, a transmitted optical density was measured at three places Ta, Tb, and Tc in a cell with visible light, whose central wavelength was 510 nm, using a spectrophotometer (MCPD-2000 manufactured by Otsuka Electronics Co., Ltd.). At the three places, the same OD value was measured. This revealed that the blood and the dilute solution were uniformly mixed with each other.

### Third Example

### Detection of HbA1c

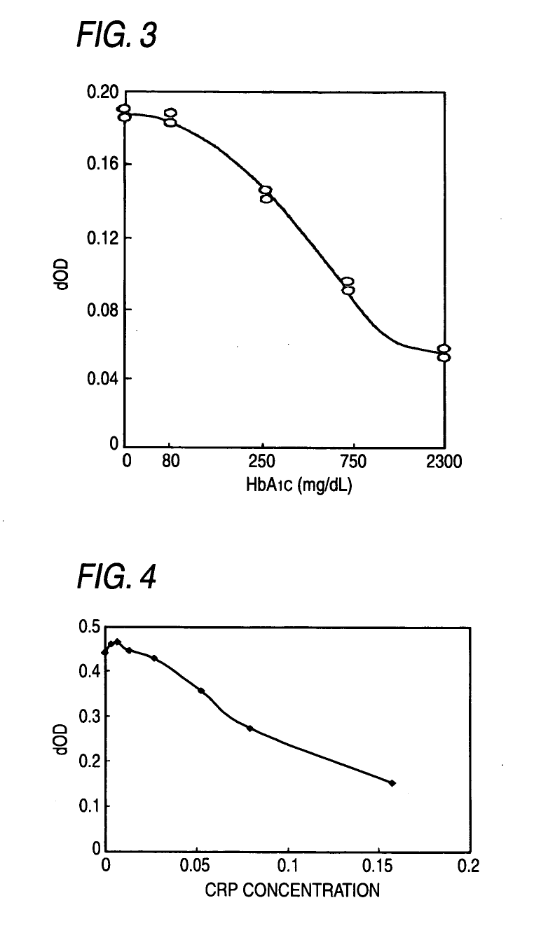

According to a method similar to a method described in the description of a second example in JP-A-8-122335, a multilayer dry slide for analysis of hemoglobin A1c was manufactured. Then, 10 μl of 50 mM glycerophosphate buffer solution containing a known amount of HbA1c in human blood (pH 7) was trickled onto the slide, which was maintained at 37° C. Subsequently, the reflected optical density was measured with visible light, whose central wavelength was 650 nm, by a spectrophotometer (MCPD-2000 manufactured by Otsuka Electronics Co., Ltd.) from the side of a PET support. Then, the difference (ΔOD₅₋₃) between the reflected optical densities at a moment, at which 3 minutes elapsed since the trickling, and at another moment, at which 5 minutes elapsed since the trickling, was obtained. Thus, a calibration curve was obtained. As is apparent from FIG. 3, a dry immunoassay element for hemoglobin Aₗc assay can determine a quantity of hemoglobin A1c with good precision.

Then, 0.5 μL of whole blood was inputted into a mixture inlet port (25 μL of the dilute solution was preliminarily inputted). Subsequently, the liquid was moved by a decompression unit (for example, a syringe pump) connected to the decompression unit connecting portion of a PDMS. A certain amount of a mixed specimen was introduced into the multilayer dry slide for analysis of hemoglobin A1c of a reaction detection portion and was maintained at 37° C. Subsequently, the reflected optical density was measured with visible light, whose central wavelength was 650 nm, by the spectrophotometer (MCPD-2000 manufactured by Otsuka Electronics Co., Ltd.) from the side of the PET support. Then, the difference (ΔOD₅₋₃) between the reflected optical densities at a moment, at which 3 minutes elapsed since the trickling, and at another moment, at which 5 minutes elapsed since the trickling, was obtained. An amount of hemoglobin A1c was obtained from a calibration curve (the number of measurements N=5). The measured value (g/dL) of hemoglobin A1c was 1.07±0.04. A CV was 3.7%.

Meanwhile, complete mixing and hemolysis were performed by performing the pipette aspiration of a same blood sample and a diluted and laked blood outside the chip. Then, the same amounts of the blood sample and the diluted and laked blood were supplied to the multilayer dry slide for analysis of hemoglobin A1c and were maintained at 37° C. Subsequently, the reflected optical density was measured with visible light, whose central wavelength was 650 nm, by the spectrophotometer (MCPD-2000 manufactured by Otsuka Electronics Co., Ltd.) from the side of the PET support, as a comparative example. Then, the difference (ΔOD₅₋₃) between the reflected optical densities at a moment, at which 3 minutes elapsed since the trickling, and at another moment, at which 5 minutes elapsed since the trickling, was obtained. An amount of hemoglobin A1c was obtained from a calibration curve (the number of measurements N=5). The measured value (g/dL) of hemoglobin A1c was 1.06±0.035. ACV was 3.3%. This mixing chip could obtain almost similar advantages to those of a conventional agitating method.

### Fourth Example

### Detection of CRP

A multilayer dry slide for CRP was manufactured according to a method similar to that used in an embodiment described in JP-A-2003-75445. Then, 10 μl of 50 mM glycerophosphate buffer solution containing a known amount of CRP in human blood (pH 7) was trickled onto this slide, which was maintained at 37° C. Subsequently, the reflected optical density was measured with visible light, whose central wavelength was 650 nm, by a spectrophotometer (MCPD-2000 manufactured by Otsuka Electronics Co., Ltd.) from the side of a PET support. Then, the difference (ΔOD₅₋₃) between the reflected optical densities at a moment, at which 3 minutes elapsed since the trickling, and at another moment, at which 5 minutes elapsed since the trickling, was obtained. Thus, a calibration curve was obtained. As is apparent from FIG. 4, a dry immunoassay element for CRP assay can determine a quantity of CRP with good precision.

Then, 1 μL of CRP standard serum, whose CRP concentration was known, was inputted into a mixture inlet port (20 μL of the dilute solution was preliminarily inputted). Subsequently, the liquid was moved by a decompression unit (for example, a syringe pump) connected to the decompression unit connecting portion of a PDMS. A certain amount of a mixed specimen was introduced into the multilayer dry slide for analysis of CRP, which was provided in a reaction detection portion and was maintained at 37° C. Subsequently, the reflected optical density was measured with visible light, whose central wavelength was 650 nm, by the spectrophotometer (MCPD-2000 manufactured by Otsuka Electronics Co., Ltd.) from the side of the PET support. Then, the difference (ΔOD₅₋₃) between the reflected optical densities at a moment, at which 3 minutes elapsed since the trickling, and at another moment, at which 5 minutes elapsed since the trickling, was obtained. An amount of CRP was obtained from a calibration curve (the number of measurements N=5). The measured value (g/dL) of CRP was 3.00±0.08. A CV was 2.7%.

Meanwhile, complete mixing was performed by performing the pipette aspiration of a same sample and a dilute solution outside the chip. Then, the same amount of obtained liquid was supplied to the multilayer dry slide for analysis of CRP and was maintained at 37° C. Subsequently, the reflected optical density was measured with visible light, whose central wavelength was 650 nm, by the spectrophotometer (MCPD-2000 manufactured by Otsuka Electronics Co., Ltd.) from the side of the PET support, as a comparative example. Then, the difference (ΔOD₅₋₃) between the reflected optical densities at a moment, at which 3 minutes elapsed since the trickling, and at another moment, at which 5 minutes elapsed since the trickling, was obtained. Consequently, an amount of CRP was obtained from a calibration curve (the number of measurements N=5). The measured value (g/dL) of CRP was 3.06±0.1. A CV was 3.2%.

### Fifth Example

### Detection of Aldehyde Dehydrogenase Gene (ALDH2)

A pyrophosphoric acid multilayer dry slide for amplification detection was manufactured according to a method similar to that used in an embodiment described in JP-A-2003-61658. Additionally, 50 μL of the following reaction liquid was preliminarily inputted to the inlet port. Further, 1 μL of refined human DNA sample and 1 μL of distilled water for reference were inputted to a mixture inlet port. Then, the liquid was moved to a temperature cycle part by a decompression unit (for example, a syringe pump) connected to the decompression unit connecting portion of a PDMS.

| | |
|---|---|
| 10× PCR Buffer | 5 μL |
| 2.5 mM dNTP | 5 μL |
| 5 μM Primer 1 | 2 μL |
| 5 μM Primer 2 | 2 μL |
| Tag | 1 μL |
| Distilled Water | 35 μL |

Primer 1
5-AACGAAGCCCAGCAAATGA-3
Primer 2
5-GGGCTGCAGGCATACACAGA-3

In this measurement, denaturing was performed 20 seconds at 94° C. Annealing was 30 seconds at 60° C. Also, the step of performing a polymerase chain reaction 1 minute 30 seconds at 72° C. was repeated 35 times. Thus, PCR amplification was performed. Then, liquid having undergone the PCR amplification was introduced into the pyrophosphoric acid multilayer dryslide for amplification detection and was maintained at 37° C. Subsequently, the reflected optical density at a moment, at which 5 minutes have elapsed since trickling, was measured with visible light, whose central wavelength was 650 nm, by the spectrophotometer (MCPD-2000 manufactured by Otsuka Electronics Co., Ltd.) from the side of the PET support.

The reflected optical density measured at a moment at which 5 minutes have elapsed since trickling.

| | |
|---|---|
| DNA sample | 0.548 |
| Distilled Water | 0.322 |

Thus, the optical density of the DNA sample was higher than that of the distilled water. Consequently, it turns out that ALDH genes can be detected.

The invention can provide a microchip enabled to simply mix given amounts of a plurality of kinds of liquid, which differ in viscosity, specific gravity, and content ratio from one another, and also can provide a mixing method and a blood testing method, each of which use the microchip.

The entire disclosure of each and every foreign patent application from which the benefit of foreign priority has been claimed in the present application is incorporated herein by reference, as if fully set forth.

What is claimed is:

1. A microchip, which comprises:
a flow path substrate;
an inlet port formed in the flow path substrate so that a plurality of kinds of liquid is introduced thereinto;
a flow path adapted to cause the plurality of kinds of liquid introduced into the inlet port to flow while mixing the plurality of kinds of liquid; and
a decompression port configured to communicate with the flow path and to be connectable to a decompression unit when atmosphere in the flow path is decompressed,
wherein the flow path includes a first flow path portion and a second flow path portion provided so that the first flow path portion and the second flow path portion are alternately formed, and
wherein the first flow path portion has a larger cross-sectional area of a cross-section perpendicular to a direction, in which the liquid flows, than the flow path portion other than the first flow path portion, and
wherein the second flow path portion has a smaller cross-sectional area of a cross-section perpendicular to the direction, in which the liquid flows, than the first flow path portion.

2. The microchip according to claim 1,
wherein the cross-sectional area of the first flow path portion is equal to or larger than twice the cross-sectional area of the second flow path portion.

3. The microchip according to claim 1,
wherein a capacity of the first flow path portion is equal to or larger than 80% of a total volume of the plurality of kinds of liquid.

4. The microchip according to claim 1,
wherein a length in a direction parallel to the direction, in which the liquid flows, of the first flow path portion ranges from 0.1 to 10 times a length in a direction parallel to the direction, in which the liquid flows, of the second flow path portion.

5. The microchip according to claim 1,
wherein a corner portion of a bottom surface of the flow path has a curvature radius that is equal to or larger than 10% of a flow path width.

6. The microchip according to claim 1,
wherein the number of the inlet port is 1.

7. The microchip according to claim 1,
wherein the plurality of kinds of liquid reciprocates in the flow path.

8. A liquid mixing method, which comprises:
mixing a plurality of kinds of liquid by utilizing a microchip according to claim 1.

9. The liquid mixing method according to claim 8,
wherein at least one kind of liquid among the plurality of kinds of liquid is preliminarily inputted to the inlet port.

10. A blood test method, which comprises:
mixing a blood with a dilute solution by utilizing a microchip according to claim 1.

11. A microchip, which comprises:
a flow path substrate;
an inlet port formed in the flow path substrate so that a plurality of kinds of liquid is introduced thereinto; and
a flow path adapted to cause the plurality of kinds of liquid introduced into the inlet port to flow while mixing the plurality of kinds of liquid,
wherein the inlet port is connectable to a compression unit when atmosphere in the flow path is compressed, and
wherein the flow path includes a first flow path portion and a second flow path portion provided so that the first flow path portion and the second flow path portion are alternately formed, and
wherein the first flow path portion has a larger cross-sectional area of a cross-section perpendicular to a direction, in which the liquid flows, than the flow path portion other than the first flow path portion, and
wherein the second flow path portion has a smaller cross-sectional area of a cross-section perpendicular to the direction, in which the liquid flows, than the first flow path portion.
